(19) United States
(12) Patent Application Publication
(10) Pub. No.: US 2007/0011739 A1
(43) Pub. Date: Jan. 11, 2007

(54) Method for increasing the security level of a user machine browsing web pages

(76) Inventors: Shay Zamir, Nesher (IL); Yanki Margalit, Ramat Gan (IL); Dany Margalit, Ramat Gan (IL)

Correspondence Address: DR. MARK FRIEDMAN LTD.;C/o Bill Polkinghorn, 9003 Florin Way, Upper Marlboro, MD, 20772, US

(21) Appl. No.: 11/167,235

(22) Filed: Jun. 28, 2005

(51) Int. Cl. G06F 12/14

(52) U.S. Cl. 726/22

(57) ABSTRACT

The present invention is directed to a method for increasing security of a machine as its user searches a web page using a search engine, the method comprising the steps of: classifying the web page by a security rank; and upon presenting a hyperlink to the web page, displaying its security rank along with the hyperlink. The method may further comprise the step of: inspecting the web page. The method may further comprise the step of: cleaning the web page of malicious content. The method may further comprise the step of: storing a cleaned copy of the web page in a cache of the search engine. The method may further comprise the step of: upon invoking the web page by the user's machine via the search engine, accessing the cleaned copy stored on the cache to the user's machine.

### FIELD OF THE INVENTION

The present invention relates to the field of preventing damages from malicious web content. More particularly, the invention relates to a method for increasing the security of a computer while the user browses the Internet using a search engine.

### BACKGROUND OF THE INVENTION

Web pages may contain harmful content. Such content can appear in many forms, including scripts, exploitable HTML tags, images manipulated to exploit known security faults, and so forth. New means of spreading malicious content are discovered and implemented daily. New security holes in browsers and e-mail clients become public rapidly, harnessed by hackers and virus writers to infect non-patched software and ultimately obtain total control over the victim's machine.

The current solutions for fighting malicious web content comprise filters disposed at a gateway to a network and/or at a user's machine. A filter may remove the malicious content from an infected object before passing it to the computer, preventing receipt of or content activation by the user's computer. But despite substantial efforts to block malicious content, it still is relayed to and accessed by computers.

One of the various means of propagating malicious content is through web sites. Web sites of well-known enterprises are relatively secure, since such enterprises are generally concerned about maintaining their good reputations, However, the motivation behind web pages of unknown or unfamiliar proprietors is open to question. This obviously affects the popularity of such web sites, since users may avoid browsing them as they present a risk. Some web sites are remunerated by publishers according to the number of times the web site has been accessed, and therefore their income is affected.

It is an object of the present invention to increase the security of a user's machine while said user browses web pages/web sites.

Other objects and advantages of the invention will become apparent as the description proceeds.

### SUMMARY OF THE INVENTION

The present invention is directed to a method for increasing security of a machine as its user searches a web page using a search engine, the method comprising the steps of: classifying the web page by a security rank; and upon presenting a hyperlink to the web page, displaying its security rank along with the hyperlink. The method may further comprise the step of: inspecting the web page. The method may further comprise the step of: cleaning the web page of malicious content. The method may further comprise the step of: storing a cleaned copy of the web page in a cache of the search engine. The method may further comprise the step of: upon invoking the web page by the user's machine via the search engine, accessing the cleaned copy stored on the cache to the user's machine.

According to a preferred embodiment of the invention, classifying the web page by a security rank is carried out during the operation of a spider program of the search engine.

The security rank is presented on the search results page by at least one icon which may present notation of page inspection, completion of cleaning the page, indication as to existence of content that may comprise malicious code within the page (like executable code), and so forth.

In another aspect, the present invention is directed to a search engine comprising: a module for classifying a web page according to a security rank; and a user interface, operative for displaying the rank along with a hyperlink to the web page.

The search engine may further comprise a module for inspecting the web page, and a module for cleaning the web page of malicious content (e.g. in case of an executable file). According to a preferred embodiment of the invention, the security rank is presented as at least one icon.

The icon may present completion of inspecting the page, an indication of a suspicion of malicious code in the page, etc.

Search results that are created by automatic search engines algorithms might lead the user to infected pages of web sites of well-known enterprises, in addition to those of unknown proprietors. Sometimes search results can be manipulated by techniques that take advantage of the specific search engine algorithms, and the infected pages are moved up in search result rank. The present invention adds a security mark to search engine results and other links to inform users of potential security hazards.

### BRIEF DESCRIPTION OF THE DRAWINGS

The present invention may be better understood in conjunction with the following figures:

FIG. 1 illustrates a web page which presents results of a search carried out by a search engine, according to the prior art.

FIG. 2 illustrates a web page which presents results of a search via search engine, according to a preferred embodiment of the invention.

FIG. 3 illustrates a web page which presents results of a search via search engine, according to another preferred embodiment of the invention.

FIG. 4 is a flowchart of a method for increasing security of a user's machine while the user searches a web page via search engine, according to a preferred embodiment of the invention.

### DETAILED DESCRIPTION OF PREFERRED EMBODIMENTS

On the Internet, the term “search engine” refers to a coordinated set of programs that typically includes:
a “spider” (also known as “crawler” or “bot”) that goes through the pages on every web site and scans, using hypertext links on each page to discover and read the site's other pages;
A “catalog”, which is a program that creates a massive index from the pages that have been read; and
A program that receives a search request from a user, compares it to the entries in the index, and returns the results to the user, typically by presenting the results in a web page.

An alternative to using a search engine is to explore a structured directory of topics. A number of Web portal sites offer both the search engine and directory approaches to finding information. Such a portal site is Yahoo™.

One of the efficient means of reaching a web site, particularly of unknown proprietors, is by search engines. However, search engines are not involved in security processing regarding web pages/web sites they point at in response to a search.

A user may assume that a web site is relatively secure if it belongs to a well-known enterprise. However, the majority of web sites do not belong to such enterprises, and consequently users avoid browsing them. As such, these web sites receive less browsing exposure than their potential.

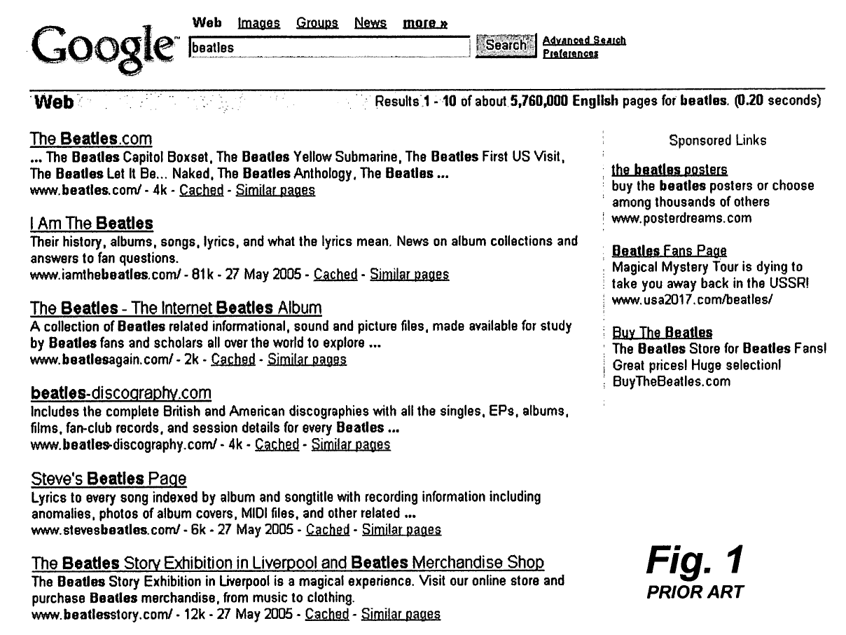

FIG. 1 illustrates a web page which presents results of a search that has been carried out by a search engine, according to the prior art. From the manner in which the results of the search are presented, a user receives no indication as to the security of the presented web sites.

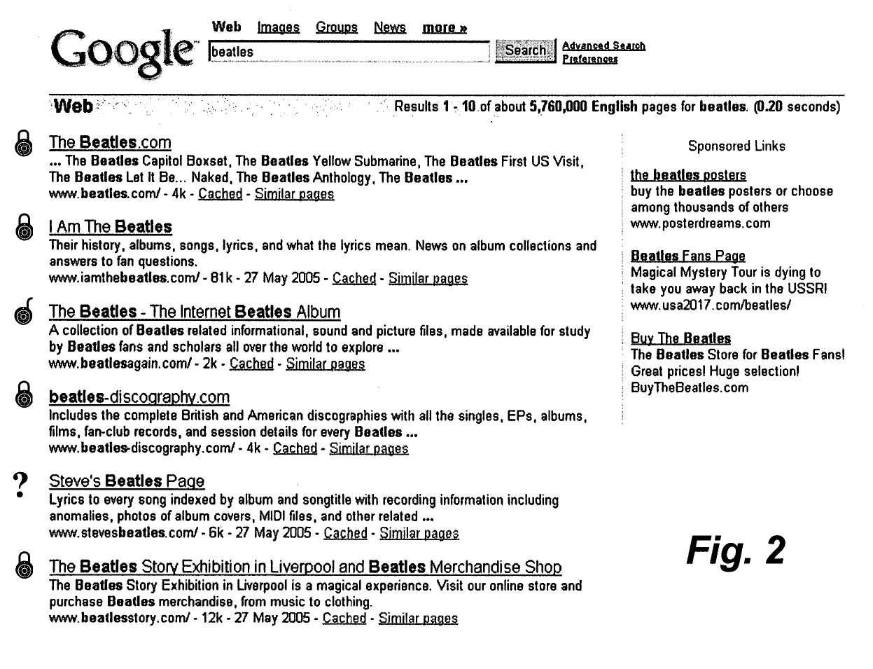

FIG. 2 illustrates a web page which presents results of a search by a search engine, according to a preferred embodiment of the invention. The state of the padlock is used to indicate whether or not the web page of the hyperlink is safe. For example, the closed padlock icon indicates that the corresponding web page/site is secure, and the open padlock icon indicates that the corresponding web page/site is not secure. In addition, the question mark indicates that the security of a web page/web site has not yet been tested by the search engine.

By adding icons to the list of the web pages/sites presented by a search engine, a user is alerted as to whether a web page/site is secure, contains malicious content, has not yet been ranked, etc. In addition, the icons can indicate existence of executable code, Java, script, advertising, etc. Icons can further describe if when browsing the web page, information from the user's computer will be sent to a remote server. In this way the user is warned of implementation of spyware.

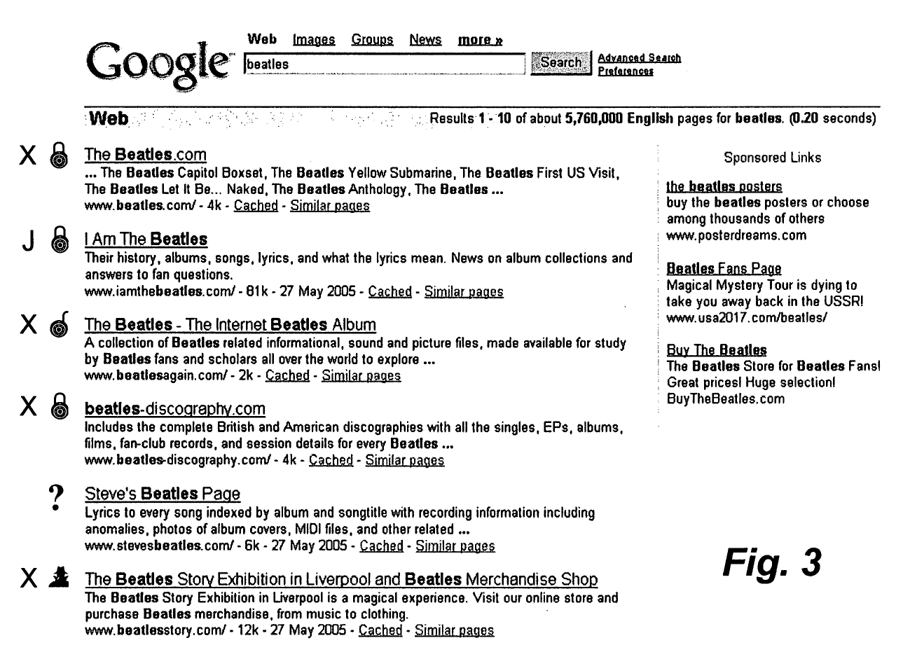

FIG. 3 illustrates a web page which presents results of a search by a search engine, according to another preferred embodiment of the invention. The “X” icon indicates whether the page/web site comprises executable code; the “J” indicates if the page/web site comprises only Java files; the detective icon indicates what inspecting the web site comprises.

Known search engines such as Google™ give the user the option of retrieving pages from the search engine cache without referring to the original page.

For example, Google™ takes a snapshot of each examined page as it crawls the web and caches these as a back-up in case the original page is unavailable. If a user clicks on the “Cached” hyperlink, the web page appears as when indexed. When the cached page is displayed, a header appears at the top to remind the user that this is not necessarily the most recent version of the page.

According to a preferred embodiment of the invention, web pages stored in the cache of a search engine are inspected, and if viruses or other malicious content is found, the pages are “cleaned”, i.e., the malicious portion is removed from the page stored in the cache of the search engine. Thus, when a user asks for a web page stored in the cache of the search engine, there is no need to inspect the page again, or at least no necessity for repetition of all the tests but limit the tests to content which does not come from the cache itself (when viewing a cached page that has pictures in it, for example, the HTML part comes from the cache, but the pictures come from the original site, and may need to be inspected again).

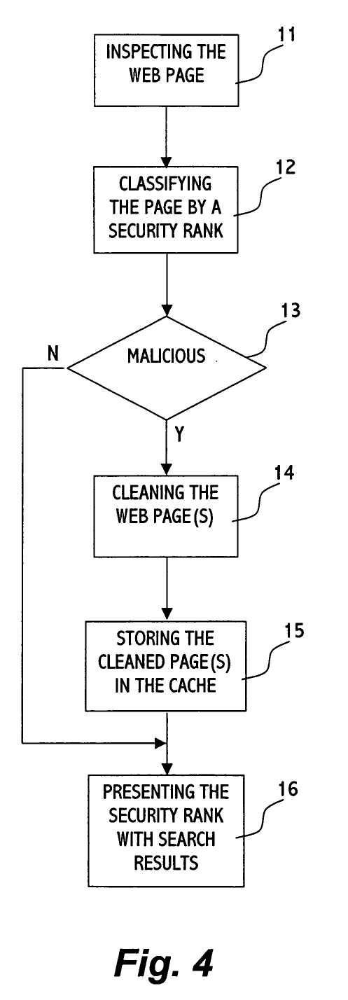

FIG. 4 is a flowchart of a method for increasing security of a user's machine searching a web page by a search engine, according to a preferred embodiment of the invention.

At block 11, a web page is inspected by an inspection facility of the search engine. The term “inspection” refers in the art to the operation of searching for viruses and other malicious content.

At block 12, the web page is classified by a security rank, according to the results of the inspection. For example, if a certain virus or malicious code is found within the web page (or the pages of a web site), then the web page/site may be ranked as “Risky”; if no virus or malicious code is found within the web page/site, then the rank may be “Safe”; and so forth.

From block 13, if the web page/site has been determined to be malicious, then the flow continues with block 14; otherwise the flow continues with block 16.

At block 14, the web page is “cleaned” from the malicious content, if possible, i.e., the malicious portion is removed from the web page. Cleaning an object of malicious content is nowadays a well-known technique.

At block 15, the cleaned web page is stored in the cache of the search engine.

At block 16, when a user institutes a search by employing the search engine, the rank of the page/site is presented along with the link of the page/site.

According to one embodiment of the invention, the security rank provides information about the current security level of a web page. According to another embodiment of the invention, the security rank provides information about the previous security of the web page, such whether a virus has been found within the page/web site during the last month(s).

According to a preferred embodiment of the invention, the cache stores only cleaned web pages. In this way, a user can be relatively sure that when browsing a cached web page, his computer is relatively secure.

Although cleaning a cached web page can be carried out any time, the best time is during operation of the spider program.

Those skilled in the art will appreciate that the invention can be embodied in other forms and ways, without losing the scope of the invention. The embodiments described herein should be considered as illustrative and not restrictive.

1. A method for increasing security of a user's machine as said user uses a search engine to search at least one web page, the method comprising the steps of:
classifying said at least one web page according to a security rank; and
upon presenting a link to each said at least one web page, presenting said security rank along with said link.

2. A method according to claim 1, further comprising:
inspecting at least one of each said at least one web page.

3. A method according to claim 2, further comprising:
cleaning said at least one inspected web page of malicious content.

4. A method according to claim 3, further comprising:
storing a copy of said at least one cleaned web page in a cache of said search engine.

5. A method according to claim 3, further comprising:
upon invoking one of said at least one web page by said user's machine via said search engine, accessing the cleaned copy of said one web page that is stored on said cache.

6. A method according to claim 1, wherein said classifying is carried out during the operation of a spider program of said search engine.

7. A method according to claim 1, wherein said security rank is presented as at least one icon.

8. A method according to claim 7, wherein said at least one icon presents completion of inspecting said page.

9. A method according to claim 7, wherein said at least one icon presents completion of cleaning said page.

10. A method according to claim 7, wherein said at least one icon presents an indication of a suspicion of malicious code in said page.

11. A method according to claim 3, wherein said content is executable code.

12. A search engine comprising:
a module for classifying a web page according to a security rank;
a user interface, operative for displaying said rank along with a hyperlink to said web page.

13. A search engine according to claim 12, further comprising a module for inspecting said web page.

14. A search engine according to claim 12, further comprising a module for cleaning said web page of malicious content.

15. A search engine according to claim 12, wherein said security rank is presented as at least one icon.

16. A search engine according to claim 15, wherein one of said at least one icon presents completion of inspecting said page.

17. A search engine according to claim 15, wherein one of said at least one icon presents completion of cleaning said page.

18. A search engine according to claim 15, wherein one of said at least one icon presents an indication of a suspicion of malicious code in said page.

19. A search engine according to claim 14, wherein said malicious content is executable code.
